(19) United States
(12) Patent Application Publication
(10) Pub. No.: US 2024/0248103 A1
(43) Pub. Date: Jul. 25, 2024

(54) METHOD AND DETECTION AREA FOR RECORDING MICROPARTICLES AND DISK-SHAPED SAMPLE CARRIER

(71) Applicant: Testo bioAnalytics GmbH, Titisee-Neustadt (DE)

(72) Inventors: Markus MÜNZER, Hinterzarten (DE); Joel RIEMER, Breitnau (DE)

(73) Assignee: Testo bioAnalytics GmbH, Titisee-Neustadt (DE)

(21) Appl. No.: 18/417,072

(22) Filed: Jan. 19, 2024

(30) Foreign Application Priority Data
Jan. 20, 2023 (DE) 102023101480.3

(51) Int. Cl. G01N 35/00

(52) U.S. Cl. CPC G01N 35/00069

(57) ABSTRACT

A method in a detection area (2) for recording microparticles (1), wherein the microparticles (1) are collected on a membrane (3) and recorded by a sequence (4) of recordings (5) along the membrane (3), and at least one reference marker (6) is recorded per recording (5).

### CROSS-REFERENCE TO RELATED APPLICATIONS

This application claims priority to German Patent Application No. 10 2023 101 480.3, filed Jan. 19, 2023, which is incorporated herein by reference as if fully set forth.

### TECHNICAL FIELD

The invention relates to a method for recording microparticles in a detection area with a membrane, wherein the microparticles are collected on the membrane and recorded by at least one recording of the membrane. Preferably, it is provided that the collected microparticles are recorded by a sequence of recordings along the membrane.

The invention also relates to a detection area for recording microparticles, in particular for carrying out a method according to the invention, comprising a recording chamber with a membrane and at least one reference marker.

The invention also relates to a disk-shaped sample carrier, which is provided in particular with microfluidics.

### BACKGROUND

It is known that microparticles to be examined can be collected on membranes for subsequent recording. Large membranes are often used to prevent clogging of the membrane by collected microparticles. However, the large membrane must be scanned completely, as the microparticles are relatively small in relation to the membrane and can therefore come to rest anywhere on the membrane. This means that a runtime for a complete scan of the large membrane is relatively time-consuming. To make matters worse, large membranes tend to be uneven, which must be compensated for by a sequence of scans in the Z direction (“Z-stacking”) in order to collect all the information. This makes the runtime for detecting microparticles even longer. Furthermore, orientation on large membranes is not easily possible, as large membranes lack reference markers, especially in the center, which makes optimal localization more difficult. A lack of orientation can lead to long run times and/or loss of information, particularly in the event of a disturbance.

### SUMMARY

It is therefore the object of the invention to improve the detection of microparticles on membranes.

To solve said object, one or more of the features disclosed herein are provided according to the invention. In particular, it is thus proposed according to the invention for solving the said object in a method of the type described at the beginning that at least one reference marker is recorded per image. This means that orientation on the membrane is always possible, whereby the runtime of a measurement can be kept short. Furthermore, double measurements can also be avoided, which increases measurement accuracy. This improves the detection of microparticles on membranes.

It may be provided that at least two different positions of the reference marker are recorded when recording the at least one reference marker, in particular where the two different positions are located on opposite sides of the recording. In this way, orientation on the membrane can be realized particularly reliably.

Furthermore, detection of the microparticles can be continued after a disturbance, as it can be known by a method according to the invention, in particular by the reference markers already recorded with the recordings made, which area of the membrane was recorded up to the time of the disturbance. This means that measurements can also be completed after a disturbance, which means that no valuable samples or information are lost.

A (non-exhaustive) list of microparticles may include, for example: living or organic matter, in particular microorganisms such as bacteria, fungi and protozoa, and viruses and parts thereof, and dead or inorganic matter, for example dust and/or soot particles.

In a method according to the invention, it is preferably provided that a plurality of images are taken along the membrane, which are laterally offset from one another. A recording can be a single image. It may also be provided that several images per recording segment of the membrane are superimposed to form an image. This makes the method very flexible and less susceptible to disturbances.

A membrane can be designed in such a way that a large number of different microparticles can be absorbed and collected in a method according to the invention. Microparticles to be examined can be inorganic and/or organic, wherein organic microparticles can preferably be of microbial origin. Thus, a method according to the invention can be used in a variety of industries, for example in the pharmaceutical and food industries.

The reference markers can be designed in different ways so that a visual distinction can be made based on the design of the reference markers. The reference markers can preferably be of different types, shapes and/or colors. In general, reference markers can be optimally adapted in a method according to the invention, whereby the method according to the invention can be further improved.

In an advantageous embodiment, it may be provided that at least two reference markers are recorded per recording. This can further improve orientation, as the use of at least two reference markers advantageously provides more information.

In particular, it is provided that the two reference markers are located on opposite sides of the recording. It may be advantageous that one reference marker can be used for two recording segments. For example, a reference marker that can be detected at a “lower” position in a recording can serve as the “upper” reference marker of another recording if membrane sections below (in the Y direction) the first recording are recorded during a process.

In an advantageous embodiment, it may be provided that at least one reference marker can always be detected between two recordings. This allows a reference marker to be used as an orientation element in order to move safely from one recording segment to the next recording segment, which is advantageous. This means that the orientation on the membrane to be examined can be maintained even in the event of a disturbance between two images.

In particular, at least two reference markers can be detectable, which makes orientation between two images even more advantageous.

In an advantageous embodiment, it may be provided that at least two different imaging distances per recording segment are recorded on the membrane and generated into one recording. This allows an image sequence to be detected, preferably by “Z-stacking”, which advantageously generates an image with a large depth of field. Furthermore, any unevenness of a membrane can be compensated for, which particularly improves the recording of microparticles.

In an advantageous embodiment, it may be provided that reference markers are applied to the membrane surface, by means of which the membrane surface can be identified in the Z direction. These reference markers can be in the form of reference particles, reference structures or a reference coloration of the membrane, which are applied to the membrane before or during the method.

A particularly advantageous embodiment is one that features optical differentiation based on a different color spectrum compared to a target analyte. This can reduce the number of recordings and thus the duration of the “Z-stacking” and the process can be carried out in a more targeted manner with greater precision. In addition, reference particles in particular can also be used as a control or positive control with regard to the correct function of the sample carrier.

In an advantageous embodiment it may be provided that the recording contains at least one fluorescence recording. This allows the membrane to be advantageously screened for fluorescent microparticles. This is particularly advantageous if an environmental sample has been pre-treated with fluorescent markers prior to recording in order to detect specific microparticles.

In particular, it may be provided that at least one fluorescence recording is recorded for each recording. In this way, each recording segment is advantageously scanned with fluorescence recordings, whereby a comprehensive distinction can be made between fluorescent and non-fluorescent microparticles in an environmental sample.

In an advantageous embodiment, it may be provided that the method is carried out in a fluidic channel system. This allows a method to be carried out with a small volume, which is cost-effective and therefore advantageous.

It may be provided that the fluidic channel system is designed as part of a microfluidic system. In this way, a microenvironment of the microfluidics can be designed in a controllable manner, whereby a wide range of processing and/or detection processes of the method can be carried out quickly and cost-effectively.

In an advantageous embodiment, it may be provided that in order to record microparticles in a detection area with a membrane, wherein the microparticles are collected on the membrane and recorded by at least one recording along the membrane, at least one processing step is performed prior to the recording. Thus, in a method, the sample, in particular the microparticles, can be processed to enable or improve a particular detection method. For example, microparticles can be treated with fluorescently labeled probes that can only detect specific microparticles. Thus, for example, specific microparticles can be detected by fluorescence measurements from an environmental sample. This is particularly advantageous for branches of industry, such as the pharmaceutical and food industries, which use specific detection methods for microparticles, preferably microorganisms.

The processing step can preferably take place directly on the membrane, which means that the entire collected material can be processed without loss. Another advantage is that no additional reaction space needs to be made available for the processing step. Transferring the collected microparticles to a further reaction chamber would also take time, which would be advantageously saved in a processing step on the membrane.

The method can have the advantageous method features described so far or claimed below and/or advantageous device features, whereby a method can be highly customized.

In particular, it may be provided in this case that more than one processing step can be carried out on the membrane. This means that complex processes can be carried out and/or modifications can be made that allow microparticles to be recorded even more accurately.

A method can also be designed by recording the membrane to detect microparticles. This means that microparticles can be recorded on the membrane, preferably by filming. This allows a method to be carried out particularly quickly, which means that detection results are available particularly quickly.

In an advantageous embodiment, it may be provided that the at least one processing step comprises a fixation and/or conditioning and/or coloring of the microparticles and/or a background reduction and/or a thermal and/or optical excitation. Thus, a method can be strongly adapted to the microparticles to be detected. Such processing steps, individually or in combination with further processing steps, can increase the sensitivity and/or specificity of the method, which further improves a method.

In an advantageous embodiment, it may be provided that the collected microparticles in a small volume are rinsed into a chamber connected to the detection area and treated with at least one substance held in the chamber and that the microparticles are rinsed back into the detection area for recording. In this way, a method step can be carried out in a chamber connected to the detection area. This is particularly advantageous if, for example, a labile substance has to be kept separately in a chamber so that the substance is not rendered ineffective by other processes before the microparticles treated with the substance are recorded. A substance for treating the microparticles can be a fluorescently labeled nucleic acid probe.

In an advantageous embodiment, it may be provided that a reference element can be used to focus a recording unit. The recording unit is preferably a camera. It can also be another optical device.

The reference element can be arranged so that it is at the same distance from the recording unit as the membrane. In this way, the settings of the recording unit, for example the lens settings, can be adapted to the distance to the membrane. This allows the microparticles to be optimally recorded.

The reference element can be a part of the membrane. This offers the advantage that the recording unit can be adjusted or focused precisely to the distance to the membrane. Alternatively or additionally, the reference element can also be a separate component. The component can be designed in such a way that it is particularly high-contrast and particularly easy for the recording unit to recognize, so that focusing can be improved.

Preferably, the reference element is located outside the detection area. This allows the reference element to be kept free of dirt and/or contamination so that focusing is not hindered and/or impaired by interfering factors.

Alternatively or additionally, the features of the alternative independent claim directed to a detection area are provided according to the invention for solving the said object. In particular, it is thus proposed in accordance with the invention for solving the said object in the case of a detection area of the type described at the beginning that the membrane is pretensioned in the receiving chamber. Pretensioning can reduce the ripple of a membrane, which advantageously means that fewer measurements have to be performed in the Z direction (“Z-stacking”). This leads to faster measurements, which means that several samples can be recorded and evaluated per time, which is advantageous.

Another advantage is that reduced “Z-stacking” means that the drive of a camera is subjected to less stress and is therefore more durable. This can improve the recording of microparticles.

In particular, a detection area is designed to be able to perform a method as described above or claimed below. Such a detection area is particularly advantageous, as it allows the advantageous methods to be carried out, which further improves the recording of microparticles.

The detection area is preferably designed in such a way that the at least one reference marker is visible in every image when recording microparticles on the membrane.

Alternatively or additionally, a plurality of reference markers can also be formed in the detection area so that at least the one and/or a reference marker is/are always visible when recording microparticles on the membrane during the recording.

In an advantageous embodiment, it may be provided that the membrane is pretensioned by a clamping ring or a clamping means, wherein the clamping ring or the clamping means is preferably incorporated into a receptacle. By means of a clamping ring or other clamping means known to a person skilled in the art, the membrane can be advantageously pretensioned using conventional tools or methods, whereby the membrane can be attached to a receptacle, in particular to a receptacle of the detection area, quickly and cost-effectively.

Alternatively or additionally, pretensioning can also be carried out by thermally pretreating the membrane with subsequent cooling. In this way, unevenness in the membrane can be greatly reduced.

Alternatively or additionally, it may be provided that the clamping ring or the clamping means is sealing. This is particularly advantageous if a flow of liquid flows through the detection area, for example in a fluidic channel system of a preferred microfluidic system. A sealing clamping ring (or clamping means) can thus prevent microparticles in the liquid flow from being lost and thus falsifying a recording.

In an advantageous embodiment, it may be provided that a material of the receiving chamber at least partially penetrates the membrane. In this way, the penetrating material can fasten or pretension the membrane to the receiving chamber. In addition, the penetration of the material can also reinforce the aforementioned sealing by the clamping ring or by the clamping means, which is advantageous.

In an advantageous embodiment, it may be provided that the receiving chamber and the membrane have different optical properties. For example, it may be provided that the membrane is white and the receiving chamber is black. The advantage of this is that it can be seen with the naked eye that a material of the receiving chamber penetrates the membrane, as explained above. This makes it possible to recognize with the naked eye whether the membrane has been fully attached to the receiving chamber and thus whether the membrane has been pretensioned and/or the detection chamber sealed.

In an advantageous embodiment, it may be provided that the membrane has an outlet. This allows a liquid to leave the detection area, which means that additional interfering material in the liquid would have little or no effect on a recording. This means that recordings can be evaluated more easily and quickly, especially if the microparticles are transferred to the membrane by a liquid.

In particular, it may be provided that the outlet comprises an outlet channel. This allows a targeted and space-saving outlet to be realized.

In an advantageous embodiment, it may be provided that the outlet of the membrane is vented. In this way, a possible congestion of liquid can be avoided and the membrane can dry completely.

In an advantageous embodiment, it may be provided that the membrane is of elongated design. In this way, the field of view of a camera can simultaneously capture an upper and a lower limit of a membrane. The advantage of this is that a recording sequence of the entire membrane is then mainly only necessary in the X direction (or only in the Y direction), which means that an axis system of the camera can have a longer service life.

In an advantageous embodiment, it may be provided that the receiving chamber has an inlet and an outlet. This is particularly advantageous if the microparticles are transferred to the membrane in a flow of liquid. In this way, a flow of liquid can enter the receiving chamber via the inlet and be transferred to the membrane. The outlet serves to remove excess liquid and can be in operative connection with the membrane outlet, as described above. An inlet can also be additionally designed so that the microparticles collected on the membrane are flushed and/or backwashed in a small volume into a chamber connected to the detection area in order to be recorded after at least one processing step.

Preferably, the membrane is positioned between the inlet and outlet. Preferably, the membrane is positioned below the inlet and above the outlet, whereby liquid can advantageously drip into the outlet and escape from the detection area. Overall, a receiving chamber can therefore be designed in a particularly variable manner by means of an inlet and/or outlet, wherein a wide variety of methods, as described above and/or claimed below, can be carried out.

In an advantageous embodiment, it may be provided that the at least one reference marker is formed on the membrane. Thus, the at least one reference marker is advantageously formed on the membrane, as a result of which the field of view of a camera does not extend far beyond a recording segment of the membrane. Thus, a large part of an image can image the membrane, whereby the entire membrane can be quickly recorded and analyzed.

In particular, the at least one reference marker is formed through the membrane. Thus, a recording can advantageously image an even larger part of the membrane, which means that the entire membrane can be recorded and analyzed even faster.

In particular, the at least one reference marker is formed by the edge of the membrane. Thus, one recording can advantageously image only the membrane, whereby the entire membrane can be recorded and analyzed particularly quickly, especially if the membrane is elongated as described above.

In an advantageous embodiment, it may be provided that the at least one or at least two reference markers are aligned on the membrane or towards the membrane in such a way that at least two positions of the at least one reference marker or at least two reference markers can be recorded for each recording. In this way, a method can advantageously be carried out in which at least two preferably opposite positions of the reference marker(s) can be detected per recording.

In an advantageous embodiment, it may be provided that each reference marker or each recording segment has its own identification. A specific marking allows a position to be determined even more precisely, which can be particularly advantageous in the event of faults or re-analyses if the current position or a position determined by the user is to be analyzed again.

In an advantageous embodiment, it may be provided that the detection area is located in a fluidic channel system. This allows small sample volumes of an environmental sample to be analyzed.

Preferably, the detection area is located in the microfluidics of a disk-shaped sample carrier. Thus, a small volume for recording microparticles can be carried out quickly and automatically in a method, in particular as described above or claimed below. Furthermore, a disk-shaped sample carrier can be designed for centrifugation. In this way, a recording of microparticles can be automated particularly advantageously by centrifugal microfluidics, which is very advantageous.

In particular, it may be provided that the detection area is connected to at least one chamber. In this way, the microparticles collected on the membrane can be advantageously flushed into the chamber in a small volume and treated with at least one substance held in the chamber and flushed back into the detection area for absorption.

In an advantageous embodiment, it may be provided that the chamber, in particular a cavity of the chamber, comprises at least one substance, preferably a nucleic acid probe. In this way, microorganisms can preferably be processed with nucleic acid probes for specific detection. This allows microorganisms to be advantageously detected in an environmental sample.

In an advantageous embodiment, it may be provided that the fluidic channel system comprises a foil which is preferably positioned opposite the membrane and that the foil is removable. A foil can thus seal the fluidic channel system, whereby other components, in particular the camera, can be protected from escaping fluid.

A removable foil can preferably be removed after the liquid has been transferred to the detection area. By removing the foil, a camera can also record weak signals of the microparticles to be examined, which would not be detectable by a foil fixed between the camera and membrane. This has the advantage of improving the sensitivity of a detection area.

Alternatively or additionally, the features of the alternative independent claim directed to a disk-shaped sample carrier are provided according to the invention for solving the said object. In particular, it is thus proposed according to the invention, for solving the said object in the case of disk-shaped sample carriers of the type described at the beginning, that means for carrying out a method as described above or claimed below and/or a detection area as described above and/or claimed below are formed in the disk-shaped sample carrier. A disk-shaped sample carrier can preferably be designed for use in a centrifuge. Thus, a method and/or a detection area for recording microparticles can be carried out or used fully in a fully automated manner by centrifugal microfluidics, which can be cost-saving and fast. This can also take place outside of labor-intensive analytical laboratories, which is advantageous.

In an advantageous embodiment, it may be provided that a reference element is preferably arranged outside the detection area. The reference element can be used to focus a recording unit, for example a camera.

The reference element can, for example, be a part of the membrane that is located outside the detection area. In this way, this part of the membrane does not come into contact with the reaction components of the detection method. As a result, the position of the membrane can be determined more precisely during a focus search of the camera, since the membrane outside the detection area is not subject to any optical changes caused by the reaction components in particular and can therefore be detected more reproducibly.

The reference element can also be a separate component that lies on the same plane as the membrane in relation to the camera. The reference element can also be optimized for the focus search of the camera; for example, the reference element can be particularly high-contrast. This can make it particularly easy for the camera to find the focus.

Alternatively or additionally, the features of the alternative independent claim directed to the use of a reference element of a disk-shaped sample carrier are provided for solving the said object in accordance with the invention. In particular, it is thus proposed according to the invention that the reference element is used for focusing for recording a membrane. As described above, the reference element can be a part of the membrane or a separate component, whereby the corresponding advantages described above can be achieved.

The reference element is preferably arranged outside a detection area. This allows the reference element to be kept free of contamination and/or impurities, which may originate from reaction components, for example.

Preferably, the disk-shaped sample carrier is designed as described above. This allows the advantages already described to be utilized.

### BRIEF DESCRIPTION OF THE DRAWINGS

The invention will now be described in more detail with reference to exemplary embodiments, but is not limited to these exemplary embodiments. Further exemplary embodiments are obtained by combining the features of individual or several claims with one another and/or with individual or several features of the exemplary embodiments, wherein:

FIG. 1 shows a top view of a detection area according to the invention, wherein microparticles collected on a membrane are recorded,

FIG. 2 shows a side view of a fluidic channel system with a detection area according to the invention,

FIG. 3 shows a disk-shaped sample carrier with means for carrying out a method according to the invention and a detection area according to the invention,

FIG. 4 shows a side view of a fluidic channel system in which a light source generates a light channel for focusing a camera, and

FIG. 5 shows a side view of a fluidic channel system in which a membrane for focusing a camera is partially outside a detection area.

### DETAILED DESCRIPTION

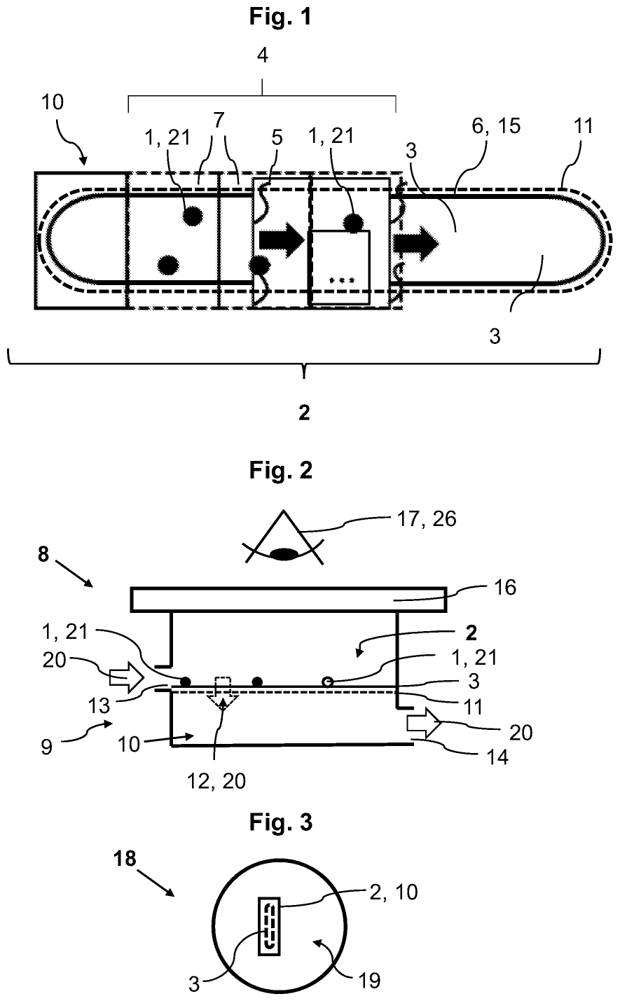

FIG. 1 shows a top view of a detection area 2 according to the invention, wherein microparticles 1 collected on a membrane 3 are recorded.

The membrane 2 is located in a receiving chamber 10, which is not shown in detail. However, the receiving chamber 10 can be designed, for example, as in the embodiment shown in FIG. 2.

The membrane 3 is pretensioned by a tension ring 11 so that the membrane 3 has little to no unevenness. The membrane 3 was previously thermally pretreated and then cooled, as a result of which the membrane 3 has particularly few regions of unevenness. The clamping ring 11 or the material of the receiving chamber 10 have different optical properties (indicated by a dashed line) than the membrane 3 (indicated by a solid line). Optical properties can be, in particular, surface structures and/or colors. As a result, it is advantageous to be able to recognize with the naked eye whether the membrane 3 has been attached to the receiving chamber 10 and thus whether the membrane 3 has been fully pretensioned and/or the detection space 2 has been fully sealed, as is the case in the embodiment shown in FIG. 1.

The membrane 3 shown in FIG. 1 is of elongated design, so that a sequence 4 of recordings 5 is required mainly in the X direction (here from left to right). The viewing area of a recording unit 26 not shown, which is designed as a camera 17, is shown as a recording segment 7.

In a method according to the invention, which could proceed as follows, a camera 17, which is not shown, scans all (see the two black arrows in FIG. 1) recording segments 7 from left to right. At least one recording 5 is taken for each recording segment 7. However, “Z-stacking” can be used to detect one image sequence per recording segment 7, which advantageously generates a recording 5 with a large depth of field. In this way, any regions of unevenness of a membrane 3 can be compensated for, which particularly improves the recording of microparticles 1. The microparticles 1 recorded in FIG. 1 are microorganisms 21, in particular bacteria.

The method shown in FIG. 1 also detects fluorescence, so that microparticles 1, 21 treated in a preparatory step can be detected particularly well and/or distinguished from non-fluorescent microparticles 1, 21 by means of fluorescence images. In the method shown in FIG. 1, at least one processing step, in this case the fluorescence labeling of microparticles 1, 21 by nucleic acid probes, is carried out before the recording 5 (not shown).

The method shown in FIG. 1 also shows that the edge 15 of the membrane 3 forms the only reference marker 6. This reference marker 6 is visible in each recording segment 7 or in each recording 5. It is also shown that at least two positions of the at least one reference marker 6 are recorded, since at least the opposite sides of the membrane 3 are detected in the X direction. This means that the orientation can be found again even in the event of a fault, for example due to mechanical slippage of the membrane 3. This improves the recording of microparticles 1, 21 such as bacteria.

Alternatively, two reference markers 6 can also be recorded per recording 5, in particular wherein the two reference markers 6 are located on opposite sides of the recording 5. Thus, two reference markers 6 could preferably circulate outside and/or inside the membrane 3 up to one half of the circumference of the membrane 3 (not shown).

In the method shown in FIG. 1, at least two positions of the reference marker 6, 15 are also always detected between two recordings 5.

FIG. 2 shows a fluidic channel system 8, having a receiving chamber 10 of a detection area 2, as shown in FIG. 1. Functionally and/or structurally similar or identical components and functional units to the exemplary embodiment shown in FIG. 1 are designated with the same reference signs and are not described again separately.

The fluidic channel system 8 is designed as part of a microfluidic system not shown, wherein the receiving chamber 10 has an inlet 13 for a liquid flow 20 provided with microparticles 1, 21. The liquid flow 20 can be transferred to the membrane 3 in a method as described above. The microparticles 1, 21 can thus be collected at the membrane 3. The liquid stream 20 can leave the detection area 2 via an outlet 12 of the membrane 3 and via an outlet 14 of the receiving chamber 10, so that interfering components of the liquid stream 20 can be removed before recording. The outlet 12 can also be vented so that an accumulation of liquid can be avoided and the membrane can dry.

The membrane 3 is pretensioned between the inlet 13 and outlet 14 by the clamping ring 11. As described above, at least one processing step can be carried out on the membrane 3. One or more processing steps, for example fixation and/or conditioning and/or coloring of the microparticles 1, 21 and/or background reduction and/or thermal and/or optical excitation, can alternatively or additionally be carried out in a chamber 9 upstream of the receiving chamber 10, which is not shown in detail. For this purpose, the microparticles 1, 21 collected on the membrane 3 can be flushed into the chamber 9 in a small volume and pretreated. After processing, the microparticles 1, 21 can then be rinsed back into the recording chamber 10 and recorded.

Recording is carried out by a camera 17 adapted to the method and known to the person skilled in the art. In FIG. 2, a foil 16 is positioned between detection area 2 and camera 17. This foil 16 seals the receiving chamber 10 while the or a liquid flow 20 passes through the receiving chamber 10. Before recording 5, the foil 16 can be removed manually and/or automatically so that the foil 16 does not interfere with recording 5 or attenuates recording signals. This means that a recording of microparticles 1, 21 can also advantageously detect weak signals.

FIG. 3 shows a disk-shaped sample carrier 18 with microfluidics as previously mentioned, comprising a fluidic channel system 8 according to FIG. 2 with a detection area 2, 10 described according to FIG. 1. Furthermore, the disk-shaped sample carrier 18 can form further means 19 for carrying out a method as previously described or subsequently claimed and/or a detection area 2 as previously described or subsequently claimed. The disk-shaped sample carrier 18 of FIG. 3 is suitable for centrifugation, whereby a recording of microparticles 1, 21 can be carried out in a particularly advantageous automated manner by centrifugal microfluidics.

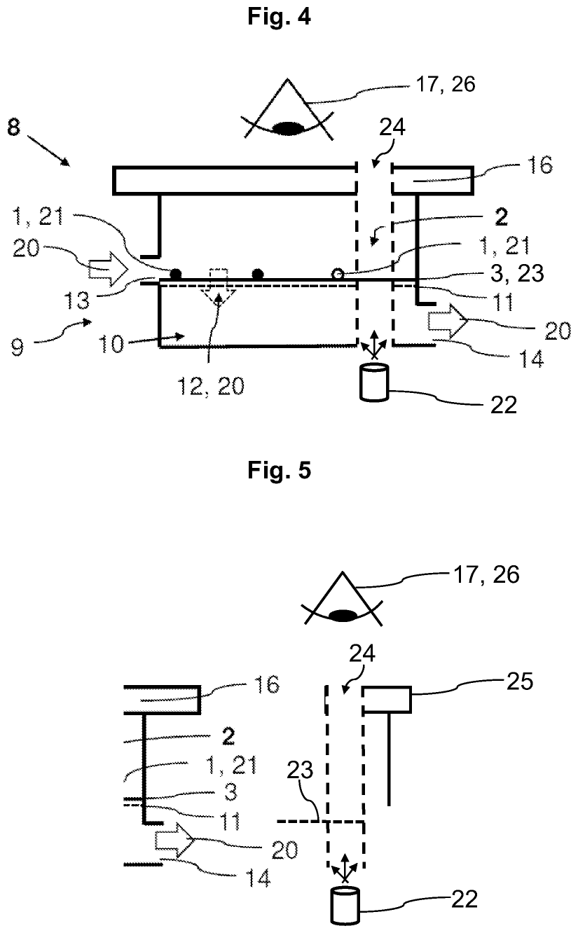

FIG. 4 shows a fluidic channel system 8 as shown in FIG. 2, wherein a light source 22 can be seen which generates a light channel 24. The light channel 24 is used for focusing the recording unit 26, which is designed as a camera 17. The light channel 24 shines through a part of the membrane 3, which is used as a reference element 23 for focusing.

When focusing the camera 17, its settings, for example its lens settings, are thus adapted to the distance to the reference element 23 and thus to the distance to the membrane 3.

FIG. 5 shows a variant of the focusing of the camera 17. Here, in contrast to the exemplary embodiment in FIG. 4, the reference element 23 for focusing the camera 17 is arranged outside the detection area 2.

The reference element 23 can be a part of the membrane 3 that enables a neutral location that is not affected by a detection reaction, as this part is located outside the detection area 2. This location is therefore free of contamination and/or air bubbles, so that it can be used advantageously for the focus search. However, the reference element 23 can also be another component, for example a high-contrast element that is particularly suitable for focusing a camera 17.

During focusing, the settings of the camera 17 are adjusted to the distance to the reference element 23 and thus to the distance to the membrane 3 using the light source 22. The light source 22 generates a light channel 24 that passes through the reference element 23 and a translucent area 25 and is directed towards the camera 17.

The invention thus generally proposes a method in a detection area 2 for recording microparticles 1, wherein the microparticles 1 are collected on a membrane 3 and recorded by a sequence 4 of recordings 5 along the membrane 3, wherein at least one reference marker 6 is recorded per recording 5. Such a method according to the invention or a detection area 2 according to the invention are of particular interest for recording and analyzing microparticles 1 in the pharmaceutical and food industries, but are not limited to these industries.

### LIST OF REFERENCE SIGNS

1 Microparticles
2 Detection area
3 Membrane
4 Sequence of 5
5 Recording
6 Reference marker
7 Recording segment
8 Fluidic channel system
9 Chamber
10 Receiving chamber
11 Clamping ring
12 Outlet of 3
13 Inlet
14 Outlet of 10
15 Edge of 3
16 Foil
17 Camera
18 Disk-shaped sample carrier
19 Means
20 Liquid flow
21 Microorganisms
22 Light source
23 Reference element
24 Light channel
25 Translucent area
26 Recording unit

1. A method for recording microparticles (1) in a detection area (2) with a membrane (3), the method comprising:
collecting the microparticles (1) on the membrane (3);
recording the microparticles by at least one recording (5) of the membrane (3); and
recording at least one reference marker (6) per recording (5).

2. The method according to claim 1, further comprising recording at least two of the reference markers (6) per recording (5), with the two reference markers (6) being located on opposite sides of the recording (5).

3. The method according to claim 1, wherein at least one of the reference markers (6) is always detectable between two of the recordings (5).

4. The method according to claim 1, further comprising recording at least two different imaging distances per recording segment (7) on the membrane (3) and generating the at least two different imaging distances per said recording segment into one of the recordings (5).

5. The method according to claim 1, wherein the recording contains at least one fluorescence recording.

6. The method according to claim 1, further comprising carrying out the method in a fluidic channel system (8).

7. A method for recording microparticles (1) in a detection area (2) with a membrane (3), the method comprising:
collecting the microparticles (1) on the membrane (3);
recording the microparticles by at least one recording (5) along the membrane (3); and
carrying out at least one processing step on the membrane (3) before the recording (5).

8. The method according to claim 7, wherein the at least one processing step comprises at least one of a fixation, conditioning, coloring of the microparticles (1), a background reduction, a thermal excitation, or an optical excitation.

9. The method according to claim 7, further comprising rinsing the collected microparticles (1) in a small volume into a chamber (9) connected to the detection area (2); treating the small volume of the microparticles with at least one substance held in the chamber (9); and rinsing the microparticles (1) back into the detection area (2) for the recording (5).

10. The method according to claim 1, further comprising using a reference element (23) to focus a recording unit (26) for making the recording and the reference element (23) is arranged outside the detection area (2).

11. A detection area (2) for recording microparticles (1), the detection area comprising: a receiving chamber (10) with a membrane (3) and at least one reference marker (6), and the membrane (3) is pretensioned in the receiving chamber (10).

12. The detection area (2) according to claim 11, wherein the membrane (3) is pretensioned by a clamping ring (11) or a clamping means, and the clamping ring (11) or the clamping means is at least one of incorporated into a receptacle or is sealing.

13. The detection area (2) according to claim 11, wherein a material of the receiving chamber (10) at least partially penetrates the membrane (3).

14. The detection area (2) according to claim 11, wherein the receiving chamber (10) and the membrane (3) have different optical properties.

15. The detection area (2) according to claim 11, wherein the membrane (3) has an outlet (12).

16. The detection area (2) according to claim 15, wherein the outlet (12) of the membrane (3) is vented.

17. The detection area (2) according to claim 11, wherein the membrane (3) is elongated.

18. The detection area (2) according to claim 11, wherein the receiving chamber (10) has an inlet (13) and an outlet (14), and the membrane (3) is positioned between the inlet (13) and the outlet (14).

19. The detection area (2) according to claim 11, wherein the at least one reference marker (6) is formed on the membrane (3).

20. The detection area (2) according to claim 11, wherein the at least one reference marker (6) or at least two of the reference markers (6) are aligned on the membrane (3) or towards the membrane (3) such that at least two positions of the at least one reference marker (6) or of the at least two reference markers (6) are adapted to be recorded for each recording (5).

21. The detection area (2) according to claim 11, wherein each said reference marker (6) or each recording segment (7) has an individualized identification.

22. The detection area (2) according to claim 11, wherein the detection area (2) is located in a fluidic channel system (8), and the detection area (2) is connected to at least one chamber (9).

23. The detection area (2) according to claim 22, wherein the at least one chamber (9) comprises at least one substance.

24. The detection area (2) according to claim 22, wherein the fluidic channel system (8) comprises a foil (16) which is at least one of positioned opposite the membrane (3) or is removable.

25. A disk-shaped sample carrier (18) comprising the detection area (2) according to claim 11.

26. The disk-shaped sample carrier (18) according to claim 25, further comprising a reference element (23) arranged outside of the detection area (2).

27. (canceled)
